(19) United States
(12) Patent Application Publication
(10) Pub. No.: US 2009/0276475 A1
(43) Pub. Date: Nov. 5, 2009

(54) SECURE DATA ACCESS AND BACKUP

(76) Inventors: Roald Ramsey, Redding, CA (US); Bruce Randall Stephens, Loma Linda, CA (US)

Correspondence Address: COOL PATENT P.C., c/o CPA Global, P.O. BOX 52050, MINNEAPOLIS, MN, 55402, US

(21) Appl. No.: 12/348,493

(22) Filed: Jan. 5, 2009

Related U.S. Application Data
(60) Provisional application No. 61/067,696, filed on Mar. 1, 2008.

(51) Int. Cl. H04M 3/16; H04W 84/12; G06F 17/30

(52) U.S. Cl. 707/204; 455/410; 370/338; 707/E17.032; 707/E17.005

(57) ABSTRACT

In accordance with one or more embodiments, data on a mobile device may be secured by receiving mobile device data to be secured from a personal computer in communication with the mobile device, securing the mobile device data with the personal computer, and backing up the secured mobile device data to a remote database coupled to a remote server or to a local database coupled to the personal computer. In accordance with one or more other embodiments, data on a personal computer may be secured by communicating with a mobile device, receiving an identifier associated with the mobile device, securing selected data on the personal computer using at least the identifier or a user provided code, or combinations thereof, and backing up the secured personal computer data to a remote database coupled to a remote server or to a local database coupled to the personal computer.

### CROSS-REFERENCE TO RELATED APPLICATIONS

The present application claims the benefit of U.S. Provisional Application No. 61/067,696 filed Mar. 1, 2008. Said Application No. 61/067,696 is hereby incorporated herein by reference in its entirety.

### BACKGROUND

The present disclosure relates generally to computer data backup and security systems and more particularly to such systems used on portable electronic devices, such as personal digital assistants (PDAs), smart cellular telephones (Smartphones), and/or laptop or computers and/or any device capable of storing data.

Many laptop computer users carry personal wireless telephones. Even though, the laptop computers may include wireless transceivers that allow communication with nearby Wi-Fi hotspots or cellular telephone networks, the user's cellular telephones are normally turned on and activated so that the user may continue to make and receive telephone calls while using the laptop computer.

Cellular telephones are normally assigned to one person who then uses the telephone to make business and private telephone calls. The user often stores personal information into the telephone which may be accessed by strangers if the telephone is lost or stolen. Recently, cellular telephone manufactures and third party application programmers have begun offering password generation software programs that can be downloaded into telephone that require the entry of a password each time the telephone is used. Because cellular telephones are so closely associated with one individual, the detection of the individual's cellular telephone or passwords on the cellular telephone may be used as a means for identifying the individual.

Various backup systems and methods are commonly used today to ensure corporate and consumer data remains safe in the event the hard drive or media is damaged or stolen. Furthermore, current encryption solutions allow users to selectively encrypt their data on the electronic device at will. One common method of backing up data requires the data to be stored on a secondary storage structure, such as an external hard drive, a thumb drive, a tape drive, or on an optical disc. This method may require that the secondary storage structure be attached or linked to the user's computer and that the secondary structure be stored in a relatively safe location. Data encryption methods are also commonly used but require the user to select the data to be protected, select the desired encryption method and the media type, and then instruct the electronic device to sequentially encrypt or decrypt the data. A main drawback with the above described backup and security methods is that both require action by the user that can be easily overlooked or postponed. Another drawback with the above described backup and security methods is that the backed-up data remains in its original state making it vulnerable to unauthorized access or use.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is an illustration of wireless data backup and security system including an electronic device having a transceiver and a backup program being connected to a wireless telephone or similar device that is capable of communicating with a remote server connected to a wireless communication network in accordance with one or more embodiments;

FIG. 2 is an illustration of a wireless phone or similar device as shown in FIG. 1 in accordance with one or more embodiments;

FIG. 3 is an illustration of an electronic device as shown in FIG. 1 having data to be backed up and or secured in accordance with one or more embodiments;

FIG. 4 is a flow diagram of a method for detecting the proximity of a wireless telephone and for allowing access to the data on the electronic device in accordance with one or more embodiments;

FIG. 5 is an illustration of a smart wireless telephone, or smartphone, capable of receiving data from an electronic device and transmitting the data on a wireless network in accordance with one or more embodiments;

FIG. 6 is a block diagram of a secure data access and backup system in accordance with one or more embodiments;

FIG. 7 is a flow diagram of a method to configure a wireless connection between a mobile device and a personal computer in the system of FIG. 6 in accordance with one or more embodiments;

FIG. 8 is a flow diagram of method to implement secure data access and backup via pairing in accordance with one or more embodiments;

FIG. 9 is a flow diagram of a method to protect and/or unprotect secure data in accordance with one or more embodiments;

FIG. 10 is a flow diagram of a method to backup secure data to a remote server in accordance with one or more embodiments;

FIG. 11 is a flow diagram of a method to backup secure data from a mobile device to a personal compute in accordance with one or more embodiments;

FIG. 12 is a flow diagram of a method to restore secure data to a personal computer from a remote server via a local application on the personal computer in accordance with one or more embodiments;

FIG. 13 is a flow diagram of a method to restore secure data to a personal computer from a remote server via a new installation or reinstallation program in accordance with one or more embodiments; and

FIG. 14 is a flow diagram of a method to restore secure data to a mobile device from a personal computer in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. Finally, the terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

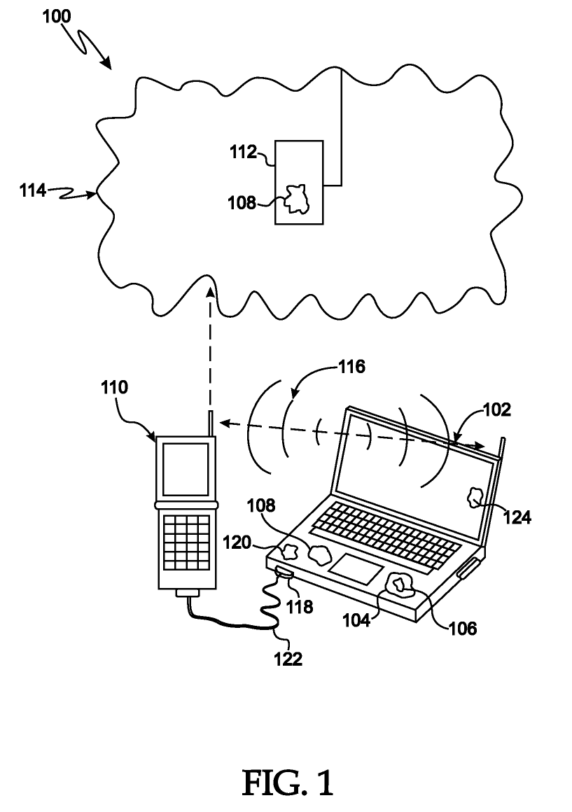

Referring now to FIG. 1, an illustration of wireless data backup and security system in accordance with one or more embodiments will be discussed. As shown in FIG. 1, system 100 comprises a data backup and security system capable of automatically and/or manually backing up data 108 from an electronic device 102 to a remote server 112 and/or to prevent unauthorized utilization of data 108. In one or more embodiments, system 100 may comprise a wireless telephone 110 or similar device capable of connecting to and communicating over a wireless communication network 114. In one or more embodiments, wireless telephone 110 comprises a cellular telephone, Smartphone, personal digital assistant, and/or any other portable device capable of communicating over a wireless communication network. Similarly, in one or more embodiments wireless network 114 may comprise a wireless telephone network or the like, and in general may comprise a wireless wide area network (WWAN) or the like such as a cellular telephone or data network capable of communicating in accordance with one or more wireless standards such as Global System for Mobile communications (GSM), Enhanced Data Rates for GSM Evolution (EDGE), General Packet Radio Service (GPRS), Universal Mobile Telephone System (UMTS), High-Speed Downlink Packet Access (HDSPA), Third-Generation of telecommunication standards (3G), Third-Generation Partnership Project Long Term Evolution (3G LTE), Fourth-Generation of telecommunication standards (4G), code division multiple access (CDMA), Evolution-Data Optimized (EVDO), wideband CMDMA (W-CDMA), Worldwide Interoperability for Microwave Access (WiMAX), and so on, and the scope of the claimed subject matter is not limited in this respect. Connected between the electronic device 102 and wireless telephone 110 is a communication link 116 that allows data 108 from the electronic device 102 to be transmitted to and from the wireless telephone 110 and eventually to the remote server 112.

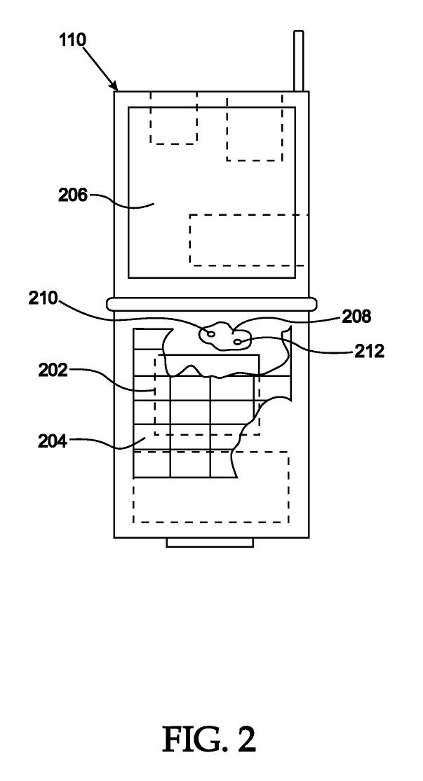

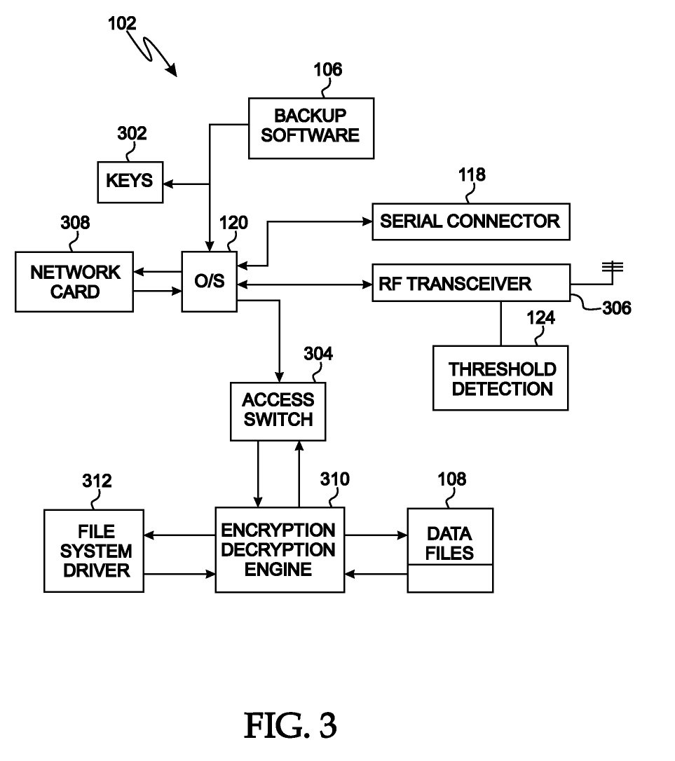

Referring now to FIG. 2, an illustration of a wireless phone or similar device as shown in FIG. 1 in accordance with one or more embodiments will be discussed. As shown in FIG. 2, wireless telephone 110 includes a radio-frequency (RF) transceiver 202, a key pad 204, a display 206, and a memory 208 which may comprise random access memory (RAM) and/or read only memory (ROM) such as electrically erasable programmable read-only memory (EEPROM), flash memory, and so on. Loaded into memory 208 is a backup data transfer program 210 designed to receive data 108 from the electronic device 102 of FIG. 1. Wireless telephone 110 may include a unique identification key or password 212 that is selectively and/or automatically transmitted to electronic device 102 when wireless telephone 110 is in close proximity to electronic device 102. In one or more embodiments, communication link 116 of FIG. 1 may operate via two shorter distance RF transceivers such as transceiver 202 of wireless telephone 110 and transceiver 306 of electronic device 102 (see FIG. 3). In one or more embodiments, transceiver 202 and transceiver 306 may operate in accordance with one or more wireless standards such as Bluetooth, ZigBee, Ultra-wideband (UWB), and/or Wi-Fi standards such as the Institute of Electrical and Electronics Engineers (IEEE) standards such as IEEE 802.11a/b/g/n, or the like. Once a communication link 116 has been established, a unique identification key or password 212 may be exchanged between the electron device 102 and wireless telephone 110.

Loaded into memory 104 of electronic device 102 is a backup software program 106 that sends the data 108 stored on electronic device 102 to be backed up to remote data server 112, for example in predetermined intervals when wireless telephone 110 is in close proximity to electronic device 102. The user initially uses the backup software program 106 to select data 108 and the backup intervals. When wireless telephone 110 is within close proximity to electronic device 102, the backup software program 106 may automatically begin the backup process sending the data 108 to remote storage server 112 via wireless telephone 110 and wireless network 114. Proximal detection of wireless telephone 110 the electronic device 102 and/or the use of the identification key or password 212 allows access to the data 108 of electronic device 102.

Referring now to FIG. 3, an illustration of an electronic device as shown in FIG. 1 having data to be backed up and or secured in accordance with one or more embodiments will be discussed. FIG. 3 shows an illustration of electronic device 102 as shown in FIG. 1, which may comprise a laptop computer or similar device, containing private data files 108 to be backed up. The data files 108 may be sent to wireless telephone 110 via RF transceivers 202 and 306 via wireless link 116, or alternatively via a wired link such as cable 122 that connects to input/output (I/O) ports on the respective devices, for example via a serial connector 118, such as a Universal Serial Bus (USB) port, of electronic device 102. Electronic device 102 may include an operating system (OS) software program 120 loaded into its working memory that controls the operation of electronic device 102 and the backup software program 106. Electronic device 102 may include an access switch 304 that controls access to an encryption and decryption engine 310 also located on electronic device 102. Encryption and decryption engine 310 operates as an intermediate between file system driver 312 and data files 108. Electronic device 102 also includes a wireless signal threshold detector 124 that detects the strength of the wireless signals between the two RF transceivers 202 and 306. In the embodiment shown in FIG. 3, threshold detector 124 is coupled to RF transceiver 306 in electronic device 102. It should be understood however, that threshold detector 124 alternatively may be located in wireless telephone 110. In some embodiments, electronic device 102 may include keys 302 and/or network card 308, although the scope of the claimed subject matter is not limited in these respects.

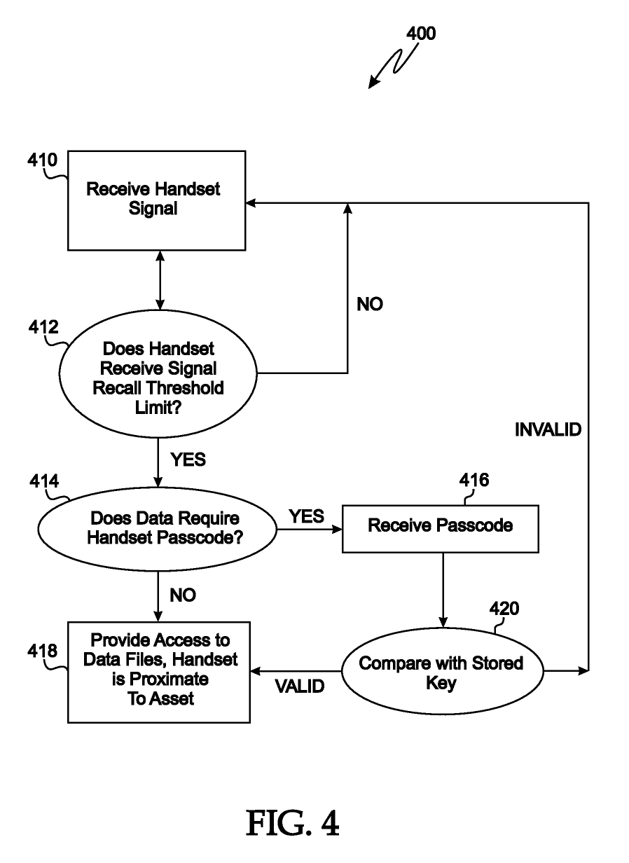

Referring now FIG. 4, a flow diagram of a method for detecting the proximity of a wireless telephone and for allowing access to the data on the electronic device in accordance with one or more embodiments will be discussed. As shown in FIG. 4, method 400 may comprise more or fewer blocks which may be arranged in one or more alternate orders, to implement detecting the proximity of wireless telephone 110 to electronic device 102. During the detection process embodied by method 400, a signal from wireless telephone 110 (or handset) may be received by electronic device 102 at block 410. A determination may be made at block 412 if the signal from wireless telephone 110 meets or exceeds a threshold level or limit, for example using a received signal strength indication (RSSI) value of the signal received from wireless telephone 110. If the received signal meets or exceeds the threshold value, then method may continue at block 414, otherwise if not then method 400 continues at block 410 until a received signal meets or exceeds threshold value. In some embodiments, before advancing to block 414, a determination may be made whether wireless telephone 110 is an approved pairing device, for example if an identification number of the phone is in a list of approved devices for electronic device 102. If wireless telephone 110 is an approved device, then method 400 may continue at block 414, otherwise method 400 may be halted for this particular wireless telephone 110 as not being an approved pairing device. A determination may be made at block 414 whether the data 108 is password protected or otherwise utilizes an encryption key to access the data 108. If the data 108 on electronic device 102 utilizes a key or is password protected, then wireless telephone 110 may transmit the password and/or key at block 416. Otherwise, if the data is not password protected or does not utilize an encryption key, the data 108 may be accessed at block 418. Electronic device 102 may receive the password and/or key transmitted from wireless telephone 110 at block 416, and then transmitted key and/or password 212 is then compared to a stored key in key database 302 on electronic device 102 at block 420. If the key and/or password 212 matches the key and/or password in the key database 302, and or otherwise decrypts the data 108 using key based decryption techniques, and/or is in general valid, then access to the data files 108 may be provided at block 418. However if the password and/or key is otherwise invalid, then access to the data 108 is not provided, and instead method 400 continues at block 410 at least until a valid password and/or key is received and processed according to method 400. If access is provided to data 108 at block 418, the backup software program 106 may initiate backing up the data 108 to remote server 112. It should be noted that method 400 as illustrated in FIG. 4 is merely one example technique for detecting proximity and/or providing access to data 108 and to backup the data 108 to a remote server 112 via wireless telephone 110 and wireless network 114, and the scope of the claimed subject matter is not limited in these respects.

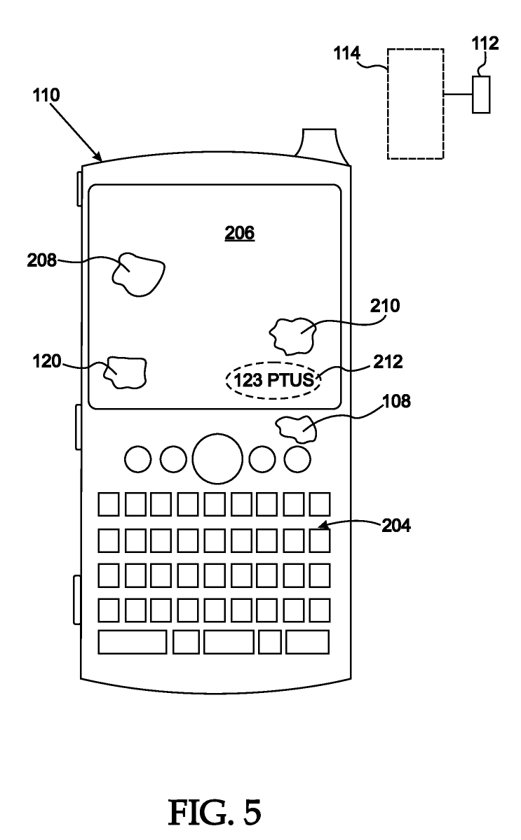

Referring now to FIG. 5, an illustration of a smart wireless telephone, or smartphone, capable of receiving data from an electronic device and transmitting the data on a wireless network in accordance with one or more embodiments will be discussed. In the embodiment shown in FIG. 5, electronic device 102 optionally may be eliminated with the data 108 being imputed directly into a “smart” version of wireless telephone 110, also referred to as a smartphone. In such embodiments, wireless telephone 110 may include an alpha-numeric key pad 204, a display 206 and memory 208 such as RAM, EEPROM, and/or flash memory. Loaded into the memory 208 is a backup data transfer program 210 capable of communicating and/or transferring data 108 stored on wireless telephone 110 to remote server 112 via wireless network 114. Optionally, wireless telephone 110 may include a unique identification key, encryption key, and/or password 212 that is selectively and/or automatically transmitted to remote server 112. In one or more embodiments of system 100 and its respective elements as shown for example in FIG. 1 and/or FIG. 5, data synchronization software programs 106 and/or 210 may be used on electronic device 102 and/or on wireless telephone 110 respectively, so that only new and/or changed data 108 is backed up to the remote server 112 with subsequent backups after an initial backup, although the scope of the claimed subject matter is not limited in these respects.

Using the above discussed system 100, a method of backing up data from an electronic device may comprise the following in one or more embodiments: operating an electronic device with data that needs to be backed up, the electronic device including an RF transceiver and a backup data software program; selecting a wireless telephone that connects to a wireless telephone network, the wireless telephone including an RF transceiver capable of communicating with the RF transceiver connected to the electronic device; connecting to a remote server via the wireless network, the remote server being capable of receiving backup data from the wireless telephone; positioning the electronic device and the wireless telephone in proximity so that their respective RF transceivers are able to communicate; authenticating the wireless telephone with the electronic device; and backing up the data from the electronic device to the remote serve with the wireless telephone via the wireless network. However this is merely one example embodiment how system 100 may be utilized, and the scope of the claimed subject matter is not limited in this respect.

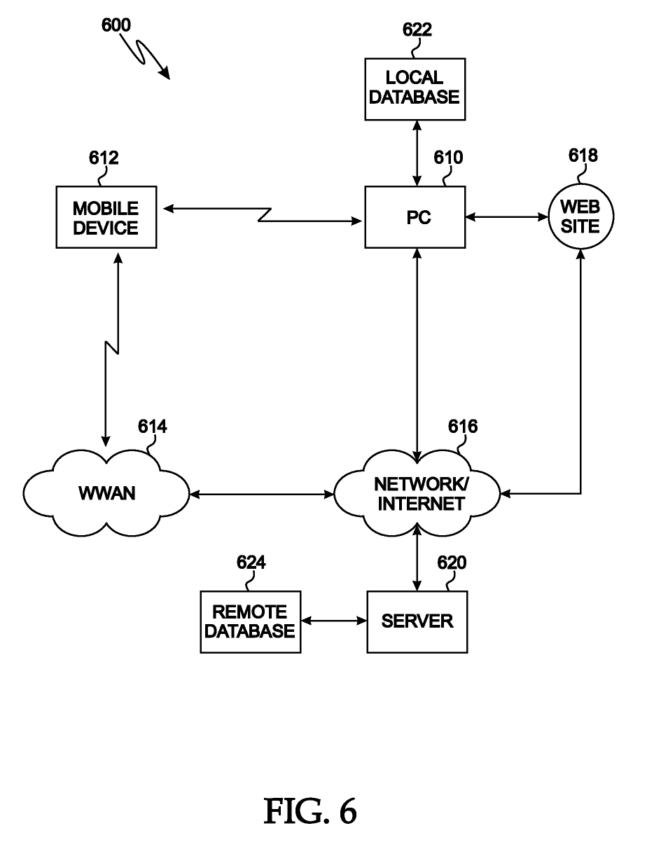

Referring now to FIG. 6, a block diagram of a secure data access and backup system in accordance with one or more embodiments will be discussed. As shown in FIG. 6, system 600 comprises a personal computer (PC) 610 such as a laptop computer, notebook computer, netbook computer, or similar device, and in general may be referred to as PC 610. In some embodiment, PC 610 may also comprise a desktop computer, server, or other electronic device having a general purpose, programmable processor, and the scope of the claimed subject matter is not limited in this respect. A user of PC 610 may also have a mobile device 612 which may comprise, for example, a cellular telephone, a personal digital assistant (PDA), smartphone, netbook computer, or the like, and in general mobile device 612 may comprise any device having wireless communication abilities which in general may be more mobile and/or portable than PC 610, although the scope of the claimed subject matter is not limited in this respect. In some embodiments, mobile device 612 may comprise a wireless dongle, although the scope of the claimed subject matter is not limited in this respect.

In system 600 of FIG. 6, mobile device 612 is capable of communicating via a wireless communication such as via wireless wide area network (WWAN) 614 such as a cellular telephone and/or data network. Communicating via WWAN 614 may allow mobile device 612 to communicate via network 616, which may comprise the Internet, to communicate with server 620 coupled to network 616. Alternatively, server 620 may be coupled to WWAN 614 to allow mobile device 612 to communicate with server 620 via WWAN 614 without requiring such communication to be routed through network 616, although the scope of the claimed subject matter is not limited in this respect. Server 620 may in turn be coupled to remote database 624 which may be stored on a storage device of server 620 such as a local hard disk drive, or alternatively remote database 624 may be disposed in a device such as storage device that server is capable of accessing such as a network attached storage (NAS) device or the like. Likewise, PC 610 may be coupled to a local database 622 which may be stored on a storage device of PC 610 such as a local hard disk drive or the like, or alternatively local database 622 may be stored on a device coupled to PC 610 such as a flash drive or external hard disk drive or the like. In one or more embodiments, PC 610 may be capable of communicating with server 620 via network 616 via a direct connection or alternatively via website 618 as an interface to server 620 via network 616.

In one or more embodiments, as will be discussed further herein, PC 610 may include an application capable of running thereon to implement secure access and backup of data stored on PC 610 and/or stored on mobile device 612 to local database 622 and/or remote database 624. The application on PC 610 may be referred to herein as a smart client, which further may be capable of encrypting and decrypting the data, and/or compressing and decompressing the data as part of the secure access and backup processes implemented by system 600. In one or more embodiments, the application may include a graphical user interface (GUI) provide for the ability for a user to select files for protection by the protection and backup service implemented by system 600 and further to determine the state of the protection from the PC 610 to server 620. In some embodiments, the application would include code in various .NET languages such as available from Microsoft Corporation of Redmond, Wash., USA, although the scope of the claimed subject matter is not limited in this respect.

In one or more embodiments, PC 610 may include a local wireless connection such as Bluetooth, Ultra-Wideband, Wireless Universal Serial Bus (USB) or the like, or alternatively utilize an external Bluetooth and/or USB dongle, to communicate with mobile device 612 which may include its own wireless hardware for communicating with PC 610. In general, the wireless link between mobile device 612 and PC 610 may be referred to herein as a Bluetooth link, however this may encompass any wireless and/or wired link between mobile device 612 and PC 610. In one specific embodiment, PC 610 may comprise a laptop computer and mobile device 612 may comprise a cellular telephone capable of communicating with PC 610 via a Bluetooth wireless link wherein each device has an appropriate Bluetooth stack to implement Bluetooth functionality. Furthermore, sever 620 may include the appropriate software running thereon to implement web and/or data storage to function as a storage server for backing up and/or restoring files. In one or more embodiments, server 620 may comprise two or more servers, for example server blades and/or processors and/or processor cores and accompanying hardware, and in one or more embodiments may comprise one or multiple virtual servers for example using virtualization software. In one embodiment, server 620 may comprise a Background Intelligent Transfer Services (BITS) enabled Internet Information Services (IIS) server via WINDOWS server software available from Microsoft Corporation of Redmond, Wash., USA, although the scope of the claimed subject matter is not limited in these respects.

During operation of system 600, files and/or folders on PC 610 may be selected by the user for encryption and/or compression and/or backup via the smart client application running on PC 610. In the event a folder is selected, by default files that are stored in the folder may automatically be protected by the smart client via a protection process. In general, once protected such files and/or folders will not be able to be opened by anyone accessing PC 610 unless the user is authenticated, for example by utilizing the Bluetooth enabled mobile device 612 and/or via manual override. As a result, the files and/or folders may be protected from loss if PC 610 experiences unauthorized access by an unauthorized user. In addition to file encryption, selected files and/or folders (data) may be compressed and sent to a remote server 620 for backup. The data that is sent to server 620 may be transmitted in an encrypted state for security reasons and may remain encrypted and/or compressed while stored in local database 624. The user will subsequently have the ability to select data on remote server 620 to be restored locally. Furthermore, data that is located on mobile device 612 may also be backed up to the remote server 620 for storage in remote database 624. In one or more embodiments, data from mobile device 612 may be transferred to PC 610 so that the PC 610 may perform encryption and/or compression by utilizing the processor and/or other resources of PC 610 for performing such encryption and/or compression. In one or more embodiments, such data transfer, encryption, compression, and/or backup may occur continuously and/or automatically in the background without the need for user intervention and/or without adversely affecting the performance of mobile device 612 and/or personal computer 610. In some embodiments, certain files that reside on mobile device 612 may not be processed by the smart client of PC 610, while other files may be processed by the smart client. Such selection of files may be set by default or custom selected by the user. In one or more embodiments, files relating to emails, SMS messages, calendar data, audio and/or video may not be processed by the smart client unless selected to be handled, and contact data, pictures or image files, text or word processing files, and/or spreadsheet files may be processed by the smart client unless selected to be excluded, although this is merely one example of default file handling settings and the scope of the claimed subject matter is not limited in this respect.

As will be discussed further, below, the file transport mechanism implemented by the smart client may be capable of determining which of the available connections to server 620 is the fastest or nearly the fastest and which may comprise a wired local area network (LAN) connection, a wireless local area network (WLAN) connection, a wireless wide area network (WWAN) connection, and so on. In such an embodiment, the smart client may utilize the fastest connection available at the time of a present data transfer. In one or more embodiments, the smart client may assume that the wired LAN is the fastest connection, followed by the WLAN connection and then the WWAN connection although the smart client may use specific network metrics and/or measurements to make such determination such as measured data transfer rates and/or link quality, and the scope of the claimed subject matter is not limited in this respect. Once the smart client is configured, the data protection process may run in the background continuously and invisibly, or nearly so, to the user to protect the selected data from unauthorized access in the event that either mobile device 612 and/or PC 610 is lost, stolen or damaged. In the event mobile device 612 and/or PC 610 is lost, stolen, or damaged, the user may readily accessing the stored and/or protected data available on local database 622 and/or remote database 624. Such configuration of the smart client application is discussed in further detail, below.

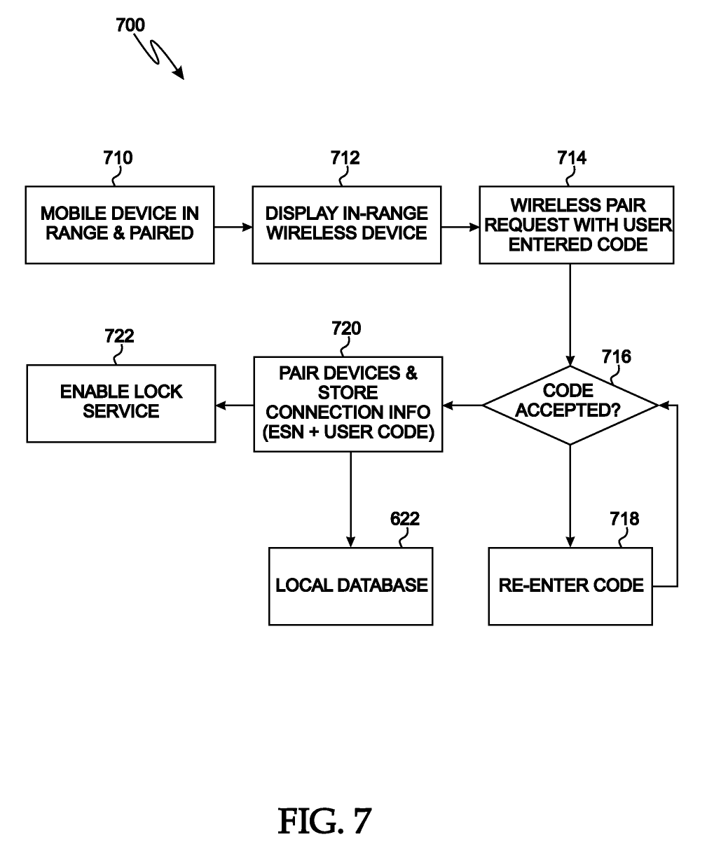

Referring now to FIG. 7, a flow diagram of a method to configure a wireless connection between a mobile device and a personal computer in the system of FIG. 6 in accordance with one or more embodiments will be discussed. A first action in configuring the smart client application via method 700 is to pair mobile device 612 to PC 610 for example via Bluetooth pairing at block 710. This may occur when mobile device 612 is located within an acceptable range of PC 610 and the devices need to be set to be discoverable via Bluetooth device pairing. If a selected mobile device 612 is located within range of PC 610, devices that are discoverable may be displayed as being within proximity in the GUI of the smart client at block 712. During initial pairing, the user may select which mobile device 612 to enable to be paired with PC 610. Once paired, the selected mobile device 612 will become the authentication device for the smart client and also be the device utilized as one of the wireless data transport mechanisms for communication via WWAN 614.

In one or more embodiments, the smart client application may utilize a combination of the Electronic Serial Number (ESN) address or a Media Access Control (MAC) address or other unique identifier of mobile device 612 and/or a unique code entered by the user as the identifier or key for security purposes to prevent the unauthorized pairing of a similar mobile device to PC 610. The user entered code may be captured by the smart client at block 714 when the application installed and/or configured locally on PC 610. If the code is not accepted at block 716, the code may be re-entered at block 718 until accepted. Once paired, a lock service may be enabled on PC 610 and/or also on mobile device 612.

In one or more embodiments, mobile device 612 may be utilized to provide secured access to protected data on PC 610, for example by locking the desktop of the PC 610 if the connection between mobile device 612 and PC 610 is lost or broken, and by unlocking the PC 610 when mobile device 612 is back in range and available and/or the wireless connection is restored, or if the manual override function is executed. In one or more embodiments, a username and password may be used to unlock PC 610 in combination with reading the ESN of mobile device 612 which may be stored at block 720 for securing data in local database 622 and for controlling a lock service which may be enabled at block 722. In some embodiments, the timing for locking and unlocking may be different. For example, to ensure that a user obtains a faster lock, the lock process may have a 5 second timer, whereas the unlock process may allow more time to allow the user to get logged in and to get to the smart client application if a manual override process is needed. In such an override process, mobile device 612 first registers a Bluetooth connection with PC 610. Then the user enters an override sequence such as actuating the <Control><ALT><Delete> keys to allow the user to enter a username and/or password. To give the user sufficient time, such an unlock timer may be set to 30 seconds to unlock the smart client application. Methods for protecting and/or unprotecting data on mobile device 612 and/or PC 610 are discussed in further detail, below.

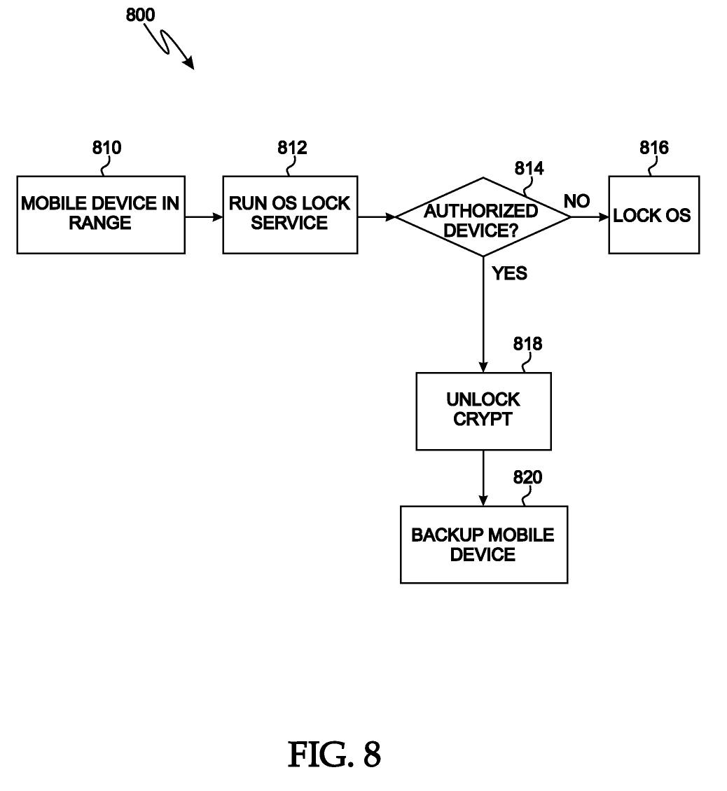

Referring now to FIG. 8, a flow diagram of method to implement secure data access and backup via pairing in accordance with one or more embodiments will be discussed. The method 800 may be implemented by the smart client application on PC 610 to monitor PC 610 to determine its connection state with mobile device 612 and to implement data backup if mobile device 612 is connected with PC 610. If a mobile device 612 is in range at block 810 with PC 610, the smart client runs the operating system (OS) lock service at block 812. A determination is made at block 814 whether the connected device is an authorized device, for example as configured in method 700 of FIG. 7. If mobile device 612 is not an authorized device then the OS may be locked at block 816, and no access to PC 610 may be permitted. In the event mobile device 612 is an authorized device, for example as configured in method 700 of FIG. 7, then the unlock service allows the user to access the OS and/or the smart client application wherein files stored on PC 610 may be decrypted and/or decompressed, and/or restored as needed at block 818. Furthermore, data on mobile device 612 may be transferred to PC 610 to be encrypted and/or compressed and backed up. In some embodiments, files that are detected as new files may be processed by the smart client, whereas files that have already been processed may not be processed again. In some embodiments, in the event the Bluetooth connection between mobile device 612 and PC 610 is lost or broken or otherwise disconnection, PC 610 may be locked at least until a Bluetooth connection with the authorize mobile device 612 is subsequently restored or a manual override process is implemented. Once a user is granted access to PC 610 via method 800, data may be protected and/or unprotected as discussed in further detail, below.

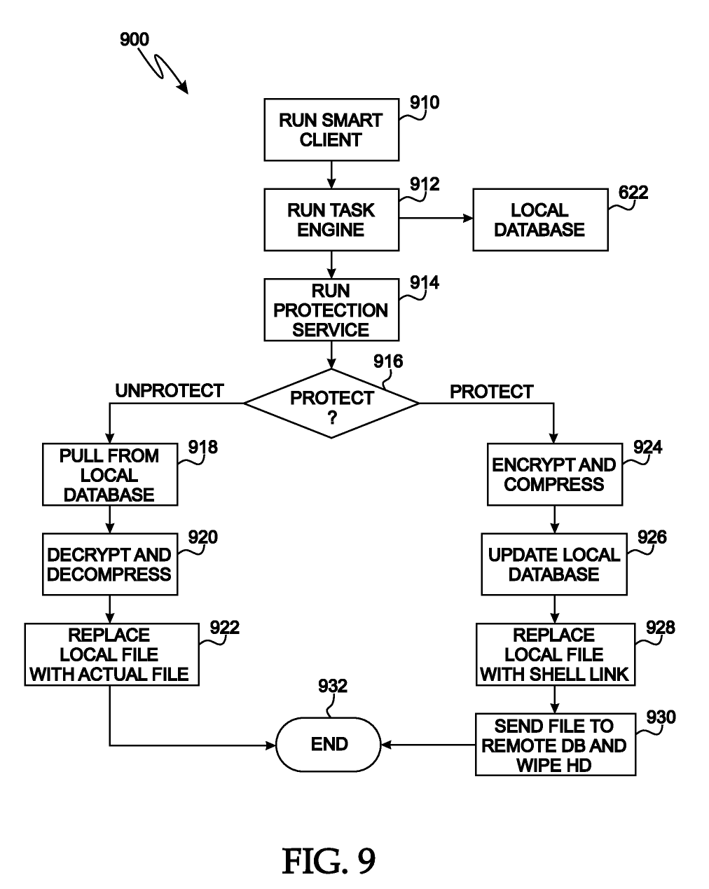

Referring now to FIG. 9, a flow diagram of a method to protect and/or unprotect secure data in accordance with one or more embodiments will be discussed. Method 900 may be utilized to secure data on PC 610 to protect against unauthorized access to the data in the event PC 610 is lost or stolen. Files and/or folders that are marked for protection via the smart client at block 910 may create a task (Mark Task) that is sent to a task engine at block 912 that will encrypt the file and/or folder by running the protection service at block 914. Files may be encrypted via an encryption routine for example using the ESN and/or a user pass code as an encryption key so that the encrypted data may not be accessible if mobile device 612 is unavailable and not communicating with PC 610, and/or an authorized manual override pass code is not entered into PC 610 In some embodiments, a majority of the data selected for protection may be selected at the folder level to allow for protection to occur as files are added to a protected folder and to be unprotected as files are removed from a protected folder. In one or more embodiments, selection of files and/or folders for protection or unprotection occur in several way, for example by selecting one or more individual files or folders with a right or secondary mouse click to show a menu and then selecting protect or unprotect from the menu. Alternatively, an explorer window may be opened in the smart client to navigate to desired files or folders which may be selected in the window for protection or unprotection. A determination may be made at block 916 whether a user has chosen to protect a file or folder that's not protected, or to unprotect a file or folder that is protected. If a file or folder is to be protected, the selected file or folder may be encrypted and optionally compressed at block 924. Files or folders that are encrypted and/or compressed may then be stored in local database 622 which may be updated at block 926, to allow downstream processes such as backup or restore to take action on the protected data as needed. Furthermore, files that are protected may have their filename appended with a select suffix such as “.ac” to indicate that such files are protected by the smart client application, and optionally the icon for the file may be replaced with a shell icon at block 928 to indicate that the file has been protected and will need to be unprotected prior to being able to be opened with the source creation program such as a word processor. Once protected, the protected files may be backed up to remote database 624 at block 930 and further the hard drive of PC 610 may be wiped to remove any temporary or cached version of the original unprotected file but stored in local database 622 as protected data.

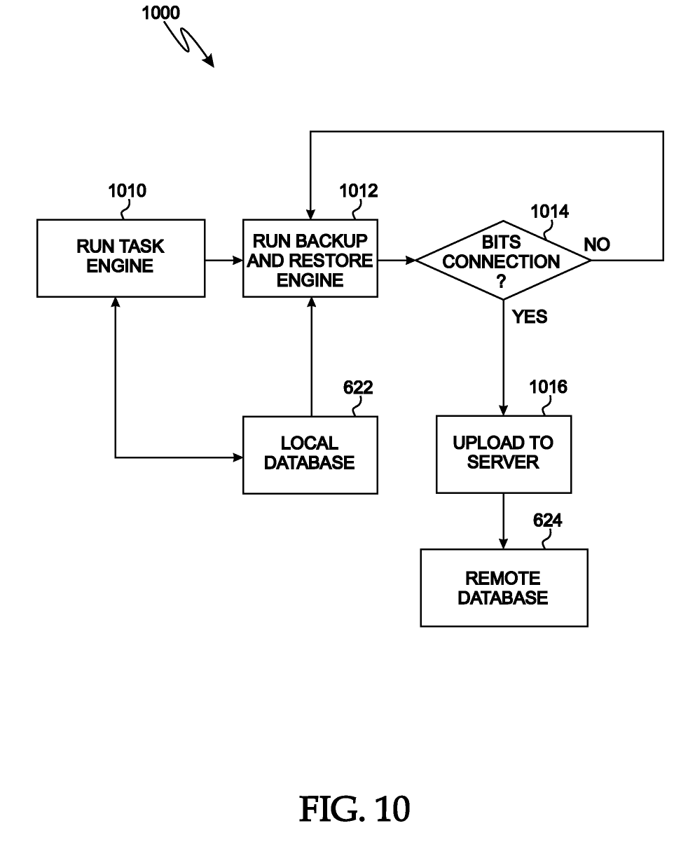

In the event a protected file or folder is to be unprotected by the smart client, the protected version of the file may be pulled from local database 622 at block 918 and then decrypted and decompressed at block 920. The local shell generated at block 928 may then be replaced with the appropriate actual file at block 922. Process 900 may end at block 932 with the protection or unprotection of selected data, and/or other processes or services may be subsequently executed. For example, in one or more embodiments, files and/or folders that were previously marked for protection by the smart client application may have metadata stored within local database 622 which may be continuously updated to allow for other automated routines to take action upon the information that is stored in local database 622. In such embodiments, a compression and/or encryption engine may run in the background at block 928 to serve the purpose of automatically compressing and preparing the selected files and folders for upload to the server 620 for storage in remote database 624 via a backup process or service. An example backup process is shown in and described with respect to FIG. 10, below.

Referring now to FIG. 10, a flow diagram of a method to backup secure data to a remote server in accordance with one or more embodiments will be discussed. In method 1000, files and/or folders that are marked for backup via upload to server 620 may be uploaded if bandwidth is available for example utilizing a BITS transport mechanism for server 620. Files that are uploaded to the server may be stored in remote database 624 and may be compresses and encrypted if not already previously compressed or encrypted. Task engine may be run at block 1010 to create tasks that may be stored in local database 622 and that feed a backup and restore engine which may be run at block 1012. A determination may be made at block 1014 whether a BITS transport mechanism is available. If not, backup and restore engine may be subsequently run at block 1012 until the BITS transport mechanism is available. In the event the BITS transport mechanism is available, then the backup and restore engine uploads the files and/or folders via the server 620 at block 1016 for storage in remote database 624. In one or more embodiments, if upload process at block 1016 is interrupted, the data may be resent when a connection is reestablished in one or more embodiments. Alternatively, partial data may be incrementally uploaded at block 1016 so that after an interruption only the unsent portion or portions of files may be uploaded until all of the data is successfully uploaded to block remote database 624. Data stored on mobile device 612 may also be implemented, for example via method 11 discussed, below.

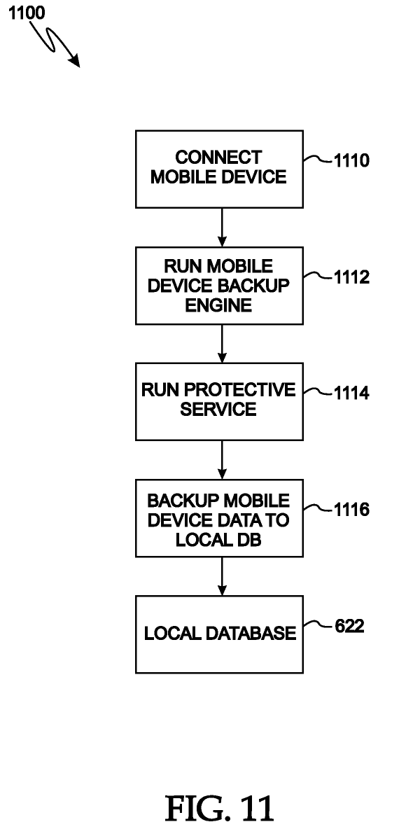

Referring now to FIG. 11, a flow diagram of a method to backup secure data from a mobile device to a personal compute in accordance with one or more embodiments will be discussed. In method 1100 shown in FIG. 11, selected data on mobile device may be protected and backed up. Mobile device 612 may be connected to PC 610 at block 1110, and then the smart client on PC 610 may run a mobile device backup engine at block 1112. In one or more embodiments, the mobile device backup engine may continuously or periodically, such as every 15 minutes, copy the data selected for backup and secure protection. Such data may include, for example, contact data, pictures or image files, and/or other static files that reside on the mobile device 612. The selected data on mobile device 612 may be copied to PC 610 and then are automatically sent to the smart client protection service which may be run as part of method 900 of FIG. 9 wherein mobile device data may be encrypted and optionally compressed. One or more blocks of method 900 may be implemented for mobile device 612 wherein protected files are encrypted and compressed and stored in local database 622. In one or more embodiments, mobile device data may be added to local database 622 along with data from PC 610 to be stored together in local database 622. Alternatively, mobile device data may be stored in a local database stored in a storage device of mobile device. In any event, mobile device 610 may leverage the processing power and/or other resources of PC 610 to perform more powerful encryption and/or compression processes, and/or to do so in a shorter time on PC 610 than would otherwise be performed by mobile device 612. For example, the processor of PC 610 may have more processor cores than the processor of mobile device 612 so that PC 610 may execute the encryption and/or compression processes faster than mobile device 612 is capable of executing. As a result, data protection processes such as method 900 may be implemented for mobile device data at least in part or entirely on PC 610, and then the protected mobile phone data may be transferred back to mobile device 612 for further handling such as to be backed up to server 620 via WWAN 614 and/or subsequently restored as needed or it may be transferred via a LAN or other network connection of PC 610 with a connection to 616 to backup to server 620.

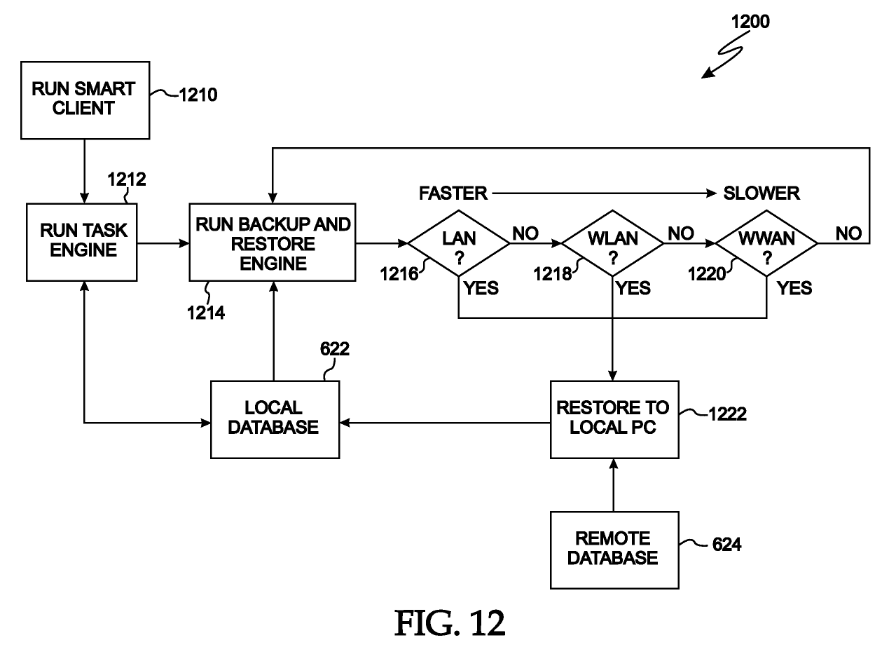

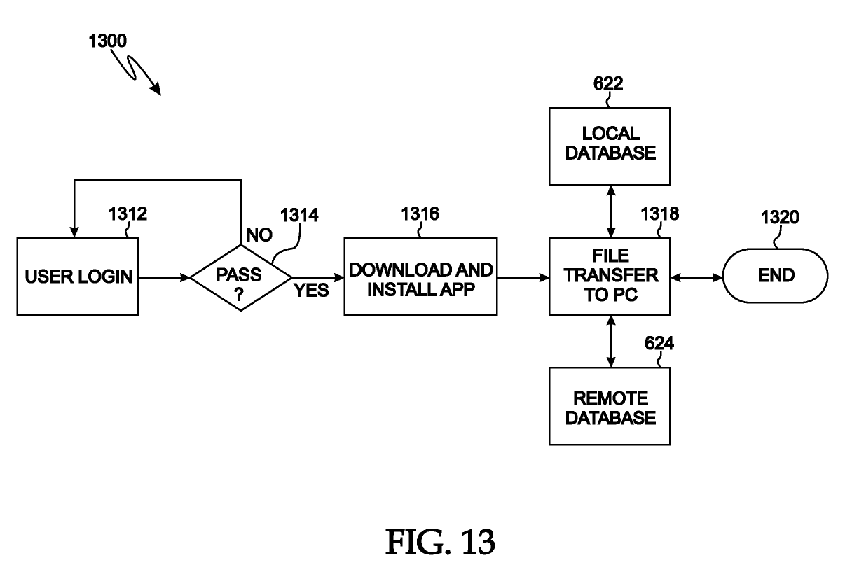

Referring now to FIG. 12, a flow diagram of a method to restore secure data to a personal computer from a remote server via a local application on the personal computer in accordance with one or more embodiments will be discussed. Method 1200 may be run in instances, for example, where data stored in local database 622 are damaged or corrupted or otherwise accidentally lost or destroyed at PC 610 and access to backup data stored in remote database 624 is desired. Otherwise, secure data may be accessed directly from local database 622. In method 1200 of FIG. 12, the smart client application may be run at block 1210 to start a restore process. A task engine may be run at block 1212 with appropriate restore tasks stored in local database 622 which may be fed to the backup and restore engine to be run at block 1214. The backup and restore engine may select which type of connection to use by determining at block 1216 whether a LAN connection is available, determining at block 1218 whether a WAN connection is available, or determining at block 1220 whether a WWAN connection is available in the same or similar manner in which the fastest available connection was determined for data upload. After an appropriate connection is determined, data stored in server 620 may be downloaded from remote database 624 and restored to local database 622 of PC 610 at block 1222. Files and/or folders that are selected by the smart client for restore from server 620 to PC 610 may be transferred, and optionally dencrypted and/or decompressed as needed, from remote database 624 to local database 622. The user should then be able, if authenticated, to open, copy, or move the file to any location that they would like to within the local file system of PC 610. The user further may have the ability to restore the file to an initial location from which that file was originally located when backed up. If the original storage location such as the folder or subfolder is not available when restoring, then an appropriate folder will be replicated or generated. In the event PC 610 is lost or destroyed, or the user otherwise gets a new PC 610 or hard drive, a new installation or reinstallation method may be implemented as discussed with respect to FIG. 13, below.

Referring now to FIG. 13, a flow diagram of a method to restore secure data to a personal computer from a remote server via a new installation or reinstallation program in accordance with one or more embodiments will be discussed. Method 1300 may be implemented in the event the user's PC 610 is lost or destroyed or otherwise if the user gets a new PC 610 or hard drive. The user may use a new PC 610 to login to server 620 at block 1312. If the user passes authentication at block 1314, then the user may download and install a new version of the smart client application at block 1316 to the new PC 610 or hard drive, and then use the smart client to restore the files from the remote database 624 from server 620 to the new PC 610, and when completed process 1300 may end at block 1320 to result in a restored system. The smart client may use the backup data from remote database 624 to rebuild local database 622 on the new PC 610.

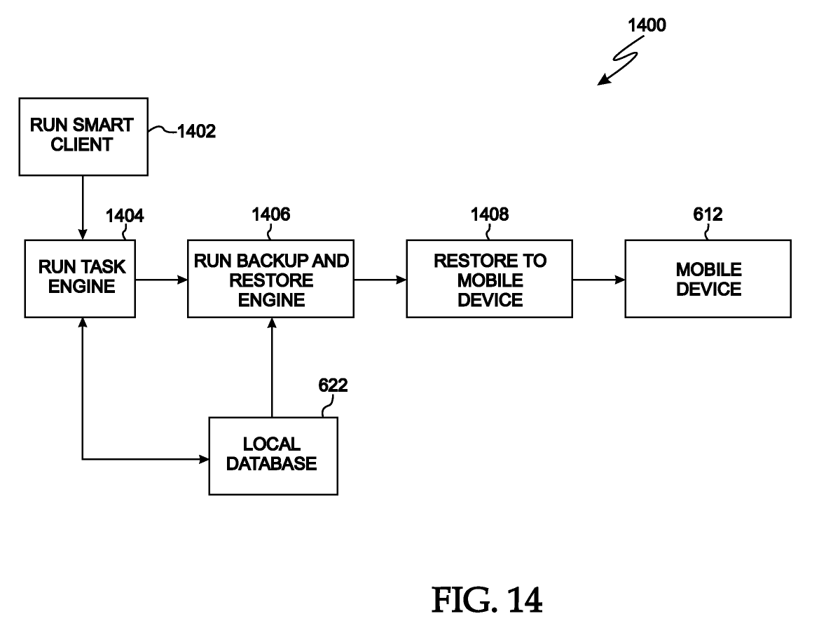

Referring now to FIG. 14, a flow diagram of a method to restore secure data to a mobile device from a personal computer in accordance with one or more embodiments will be discussed. Method 1400 may be implemented in the event that mobile device 612 or its storage device is corrupted, lost or destroyed, and the user desires to restore mobile device data to the old mobile device if possible, or to a new storage device or mobile device from the PC 610. In one or more embodiments, files and folders on the mobile device 612 may be protected via the smart client of PC 610 and stored in local database 622 as a backup, and local database 622 in turn may be backed up to remote database 624. The protected mobile phone data can be indicted in the smart client application, and may appear as an additional drive on PC 610. Such an arrangement allows the user to drag and drop or cut and past files from PC 610 to mobile device 612 and from mobile device 612 to PC 610 in the way a user is able to using a GUI of an operating system.

In the event the user wants to restore the mobile device data to mobile device 612, the user runs the smart client at block 1402 on PC 610. The task engine may then run at block 1404 to obtain restore tasks from local database 622 to feed into backup and restore engine which may be run at block 1406. The backup and restore engine may then restore mobile device data to mobile device 612 at block 1408. In some embodiments, files sent to mobile device 612 from PC 610 are decompressed and decrypted in the event mobile device 612 does not include such functionality. Alternatively, files may be transferred to mobile device 612 in an encrypted or compressed form wherein mobile device 612 may be able to utilize PC 610 to decrypt or decompress the files when mobile device is connected to PC 610. In a further alternative embodiment, mobile device 612 may include an appropriate encryption/decryption or compression/decompression program so that encrypted or compressed files may be transferred to mobile device 612, and the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining to secure data access and backup and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A method to secure data on a mobile device, comprising:
receiving mobile device data to be secured from a mobile device with a personal computer in communication with the mobile device;
securing the mobile device data with the personal computer; and
backing up the secured mobile device data to a remote database coupled to a remote server or to a local database coupled to the personal computer, or combinations thereof.

2. A method as claimed in claim 1, wherein said backing up the secured mobile device data comprises transferring the secured mobile device data back to the mobile device, wherein the mobile device transfers the secured mobile device data to the remote database via a network connection of the mobile device.

3. A method as claimed in claim 1, wherein said backing up the secured mobile device data comprises determining if a network connection via the personal computer is available or if a network connection via the mobile device is available, and transferring the data to the remote database using the faster network connection that is available.

4. A method as claimed in claim 1, wherein said backing up the secured mobile device data comprises:
determining if a wired LAN connection is available, if a wireless LAN connection, or if a wireless WAN connection is available; and
transferring the data to the remote database using the faster network connection that is available.

5. A method as claimed in claim 1, wherein said securing comprises encrypting the mobile device data or compressing the mobile device data, or combinations thereof, to generate the secured mobile phone data.

6. A method as claimed in claim 1, wherein said securing comprises encrypting the mobile device data using at least an ESN of the mobile device, a MAC address of the mobile device, or a user provided code, or combinations thereof, to perform the encrypting.

7. A method as claimed in claim 1, further comprising restoring the secured mobile device data to the mobile device or to another mobile device via transferring the secured mobile device data from the local database to the mobile device or from the remote database to the mobile device, or combinations thereof.

8. A method as claimed in claim 1, further comprising:
in the event there is new data on the mobile device to be secured, or the secured mobile device data has changed, performing said receiving, said securing, and said backing up on the new or changed data.

9. A method as claimed in claim 1, further comprising preventing access to the secured mobile device data if the mobile device is not in communication with the personal computer.

10. A method as claimed in claim 1, wherein the mobile device has two wireless connections comprising a first wireless network connection to communicate with the personal computer and a second wireless network connection to communicate with the remote server, wherein said receiving comprises receiving mobile device data from the mobile device via the first wireless network connection, and said backing up comprises sending the secured mobile device data back to the mobile device and then to the remote server via the first wireless network connection and the second wireless network connection in combination.

11. A method to secure data on a personal computer, comprising:
communicating with a mobile device;
receiving an identifier associated with the mobile device;
securing selected data on the personal computer using at least the identifier or a user provided code, or combinations thereof, and
backing up the secured personal computer data to a remote database coupled to a remote server or to a local database coupled to the personal computer, or combinations thereof.

12. A method as claimed in claim 11, wherein the mobile device has two wireless connections comprising a first wireless network connection to communicate with the personal computer and a second wireless network connection to communicate with the remote server, wherein said communicating comprises communicating with the mobile device via the first wireless network connection, and said backing up comprises sending the secured personal computer data to the mobile device and then to the remote server via the first wireless network connection and the second wireless network connection in combination.

13. A method as claimed in claim 11, wherein said backing up the secured personal computer data comprises determining if a network connection via the personal computer is available or if a network connection via the mobile device is available, and transferring the data to the remote database using the faster network connection that is available.

14. A method as claimed in claim 11, wherein said backing up the secured personal computer data comprises:
determining if a wired LAN connection is available, if a wireless LAN connection, or if a wireless WAN connection is available; and
transferring the data to the remote database using the faster network connection that is available.

15. A method as claimed in claim 11, wherein said securing comprises encrypting the personal computer data or compressing the personal computer data, or combinations thereof, to generate the secured personal computer data.

16. A method as claimed in claim 11, wherein the identifier associated with the mobile device comprises an ESN of the mobile device or a MAC address of the mobile device, or combinations thereof.

17. A method as claimed in claim 11, wherein said securing comprises encrypting the personal computer data using at least the identifier of the mobile device, or a user provided code, or combinations thereof, to perform the encrypting.

18. A method as claimed in claim 11, further comprising restoring the secured personal computer data to the personal computer or to another personal computer via transferring at least part of the personal computer data from the remote database to the local database via a faster available network connection of the personal computer or the mobile device.

19. A method as claimed in claim 11, further comprising:
in the event there is new data on the personal computer to be secured, or the secured personal computer data has changed, performing said securing and said backing up on the new or changed data.

20. A method as claimed in claim 11, further comprising preventing access to the secured personal computer data if the mobile device is not in communication with the personal computer.

21. A personal computer capable of securing mobile phone data, the personal computer comprising:
means for receiving mobile device data to be secured from a mobile device with a personal computer in communication with the mobile device;
means for securing the mobile device data with the personal computer; and
means for backing up the secured mobile device data to a remote database coupled to a remote server or to a local database coupled to the personal computer, or combinations thereof.

22. A personal computer as claimed in claim 21, wherein said means for backing up the secured mobile device data comprises means for transferring the secured mobile device data back to the mobile device, wherein the mobile device transfers the secured mobile device data to the remote database via a network connection of the mobile device.

23. A personal computer as claimed in claim 21, wherein the mobile device has two wireless connections comprising a first wireless network connection to communicate with the personal computer and a second wireless network connection to communicate with the remote server, wherein said means for receiving comprises means for receiving mobile device data from the mobile device via the first wireless network connection, and said means for backing up comprises means for sending the secured mobile device data back to the mobile device and then to the remote server via the first wireless network connection and the second wireless network connection in combination.

24. A personal computer as claimed in claim 11, further comprising means for preventing access to the secured mobile device data if the mobile device is not in communication with the personal computer.

25. A personal computer capable of securing data on the personal computer, the personal computer comprising:
means for communicating with a mobile device;
means for receiving an identifier associated with the mobile device;
means for securing selected data on the personal computer using at least the identifier or a user provided code, or combinations thereof, and means for backing up the secured personal computer data to a remote database coupled to a remote server or to a local database coupled to the personal computer, or combinations thereof.

26. A personal computer as claimed in claim 25, wherein the mobile device has two wireless connections comprising a first wireless network connection to communicate with the personal computer and a second wireless network connection to communicate with the remote server, wherein said means for communicating comprises means for communicating with the mobile device via the first wireless network connection, and said means for backing up comprises means for sending the secured personal computer data to the mobile device and then to the remote server via the first wireless network connection and the second wireless network connection in combination.

27. A personal computer as claimed in claim 25, wherein said means for backing up the secured personal computer data comprises means for transferring the secured personal computer data to the mobile device, wherein the mobile device transfers the secured mobile device data to the remote database via a network connection of the mobile device.

28. A personal computer as claimed in claim 25, further comprising means for preventing access to the secured personal computer data if the mobile device is not in communication with the personal computer.
